(19) United States
(12) Patent Application Publication
(10) Pub. No.: US 2007/0024174 A1
(43) Pub. Date: Feb. 1, 2007

(54) Phoshor composite and display device employing the same

(76) Inventors: Young-Kwan Kim, Chunan-si (KR); Seung-Uk Kwon, Chunan-si (KR)

Correspondence Address: LEE & MORSE, P.C., 3141 FAIRVIEW PARK DRIVE, SUITE 500, FALLS CHURCH, VA, 22042, US

(21) Appl. No.: 11/493,008

(22) Filed: Jul. 26, 2006

(30) Foreign Application Priority Data
Jul. 29, 2005 (KR) 10-2005-0069458

(51) Int. Cl. C09K 11/77; C09K 11/72; H01J 1/62

(52) U.S. Cl. 313/485; 252/301.4 R; 313/487; 252/301.6 R

(57) ABSTRACT

The present invention relates to a phosphor composite including a first phosphor layer emitting visible light and a second phosphor layer attached to the top surface of the first phosphor layer to form an outer layer emitting long wavelength UV light from about 200 nm to about 400 nm. The phosphor composite of the present invention may be used in a display device employing a phosphor layer for forming images.

### BACKGROUND OF THE INVENTION

1. Field of the Invention

The present invention relates to a phosphor composite. More particularly, the present invention related to a phosphor composite and display devices employing the same, the phosphor composite having enhanced light-emitting efficiency and lifetime.

2. Description of the Related Art

In general, a display device may include a phosphorescent layer coated onto a substrate, e.g., panel, electrode, and so forth, such that when an external source of high energy, e.g., ultraviolet (UV) energy, electron beam, electrical energy and so forth, contacts the phosphorescent layer, the electrons in the phosphorescent layer may be excited. The excited electrons in the phosphorescent layer emit energy in a form of light. Different phosphorescent materials may emit different lights, e.g., red, green, and blue, thereby forming colored images on the display device.

An extended exposure to an external high energy source may deteriorate the chemical and physical properties of the phosphorescent layer, thereby adversely affecting its light-emitting characteristics, and subsequently reducing the lifetime of the display device by changing color coordinates and decreasing their brightness.

Accordingly, there exists a need to improve the structure of the display device in order to achieve high level of resolution and color brightness, while maintaining an extended lifetime of the phosphorescent layer. More importantly, there exists a need to improve the composition of the phosphorescent layer used in display devices to reduce the phosphorescent layer deterioration.

### SUMMARY OF THE INVENTION

The present invention is therefore directed to a phosphor composite, which substantially overcomes one or more of the disadvantages of the related art.

It is therefore a feature of an embodiment of the present invention to provide a phosphor composite which is capable of effectively improving brightness and color reproducibility, while reducing the phosphor deterioration.

At least one of the above and other features and advantages of the present invention may be realized by providing a phosphor composite including a first phosphor layer emitting visible light and a second phosphor layer emitting long wavelength UV light from about 200 nm to about 400 nm.

The second phosphor layer in accordance with the present invetion may include one or more of (Ba,Mg,Zn)₃SiO₇:Pb²⁺, (Ca,Zn)₃(PO₄)₂:Tl⁺, MgO:Gd³⁺, Y₂O₃:Gd³⁺, SrAl₁₂O₁₉:Ce, BaSi₂O₅:Pb, (Sr,Zn)MgSi₂O₇:Pb, SrB₄O₇:Eu, BaSi₂O₅:Pb²⁺, BaZn₂Si₂O₇:Pb²⁺, BaMg₂Si₂O₇:Pb²⁺, (Ba,Sr,Mg)₃Si₂O₇:Pb²⁺, (Ba,Mg,Mn)₃Si₂O₇:Pb²⁺, (Ba,Zn,Mg)₃Si₂O₇:Pb²⁺, SrB₄O₇:Eu²⁺, YPO₄:Ce, LaPO₄:Ce, (Mg,Ba)Al₁₁O₁₉:Ce, and Ca₃(PO4)₂:Tl⁺.

The phosphor composite of the present invention may include a second phosphor layer attached to the top of a first phosphor layer to form an outer layer of the phosphor composite. The thickness of the second phosphor layer may be equal to or less than about 1000 nm, and preferably from about 10 nm to about 100 nm.

In another embodiment of the present invention, the phosphor composite may include a first phosphor layer attached to the top of a second phosphor layer to form an outer layer of the phosphor composite. The thickness of the first phosphor layer, in accordance with this embodiment may be equal to or less than about 2000 nm, and preferably from about 10 nm to about 1000 nm.

In accordance with yet another embodiment of the present invention, there is provided a display device, including a phosphor composite having a first phosphor layer emitting visible light and a second phosphor layer emitting long wavelength UV light of from about 200 nm to about 400 nm.

The display device in accordance with the present invention may be a plasma display panel, a cathode ray tube, a vacuum fluorescence display, an electron emission device, a light emitting diode, a liquid crystal display, or any other display device employing phosphorescent materials to emit visible light.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1A illustrates a cross-sectional view of a phosphor composite in accordance with an embodiment of the present invention;

FIG. 1B illustrates a cross-sectional view of a phosphor composite in accordance with another embodiment of the present invention;

FIG. 2A illustrates a schematic view of a light-emitting mechanism employing a phosphor composite in accordance with the embodiment illustrated in FIG. 1A; and

FIG. 2B illustrates a schematic view of a light-emitting mechanism employing a phosphor composite in accordance with the embodiment illustrated in FIG. 1B.

### DETAILED DESCRIPTION OF THE INVENTION

Korean Patent Application No.10-2005-0069458 filed in the Korean Intellectual Property Office on Jul. 29, 2005, and entitled: “Composite Phosphor and Display Device Employing the Same,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions may be exaggerated for clarity of illustration. It will also be understood that when an element or layer is referred to as being “on” another element, layer, or substrate, it can be directly on the other element, layer, or substrate, or intervening elements or layers may also be present. Further, it will be understood that when an element or layer is referred to as being “under” another element or layer, it can be directly under, or one or more intervening elements or layers may also be present. In addition, it will also be understood that when an element or layer is referred to as being “between” two elements or layers, it can be the only element or layer between the two elements or layers, or one or more intervening elements or layers may also be present. Like reference numerals refer to like elements or layers throughout.

The present invention is directed towards a phosphor composite that may include a first phosphor layer and a second phosphor layer. The first phosphor layer may emit visible light, while the second phosphor layer may emit long wavelength UV light in the range of from about 200 nm to about 400 nm. In this regard, it should be noted that “first” and “second” with respect to the phosphor layers of the inventive phosphor composite refer to the function of each layer, i.e. emission of visible light or UV light, and not to their structural position, i.e., outer or inner layer, in the phosphor composite.

It should also be noted that “visible light” or like terminology with reference to the present invention refers to the visible electromagnetic spectrum ranging from about 380 nm to about 780 nm. The “long wavelength UV light,” “UV light” or like terminology refers to near UV light in the electromagnetic spectrum, having a wavelength ranging from about 200 nm to about 400 nm. It should further be noted that “UV energy” and like terminology with reference to the present invention refers to UV radiation having a wavelength shorter than the near UV light, i.e., a wavelength shorter than 200 nm, such as, for example, vacuum UV light.

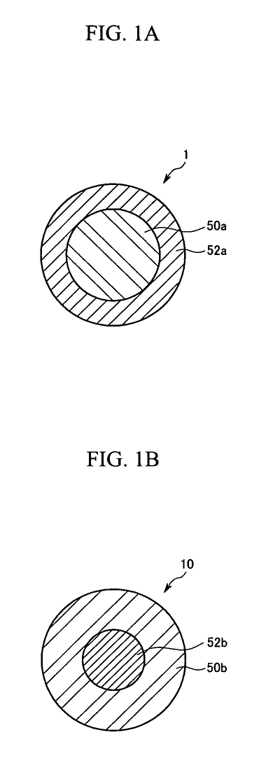

In accordance with an embodiment of the present invention and as illustrated in FIG. 1A, the phosphor composite 1 of the present invention may include a first phosphor layer 50a and a second phosphor layer 52a. The second phosphor layer 52a may be coated on the surface of the first phosphor layer 50a to form the phosphor composite of the present invention, with the second phosphor layer 52a being, in this embodiment, an outer layer. It should be noted that the first phosphor layer 50a may be selected such that it is capable of emitting visible light when contacted with an energy source, such as UV energy, electron beams, electrical energy, or the like, and the second phosphor layer 52a may be selected such that it is capable of emitting long wavelength UV light when contacted with the same energy source.

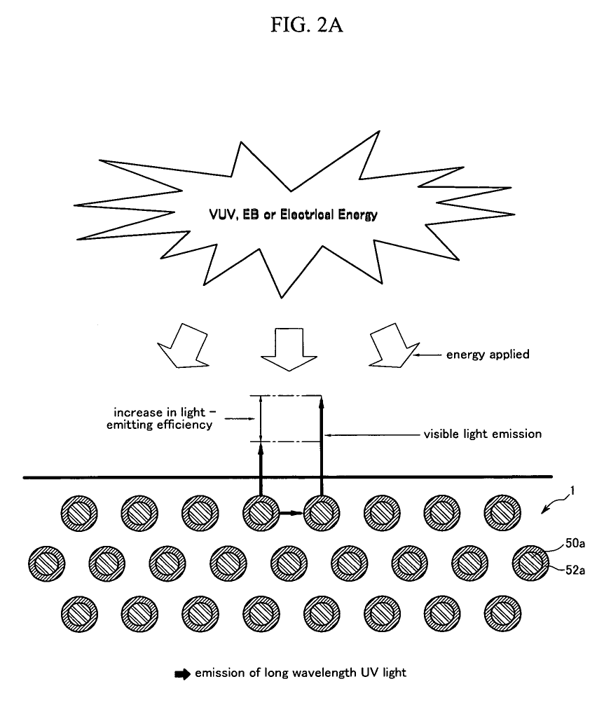

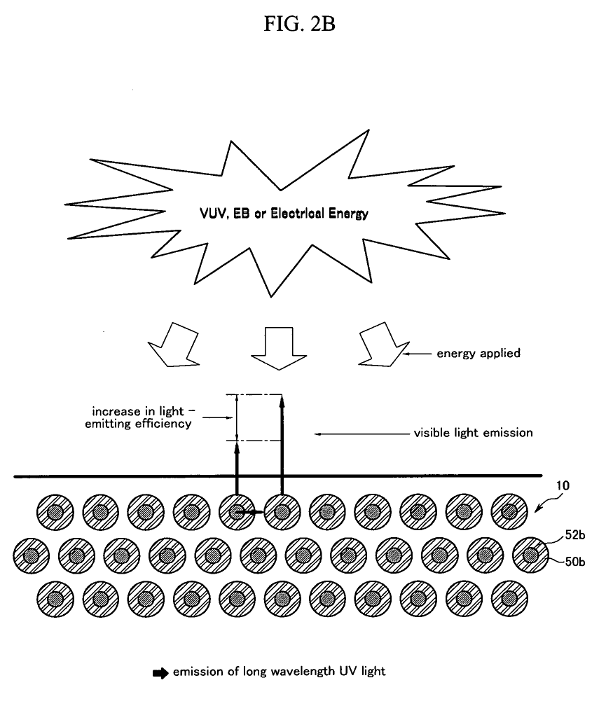

Not wanting to be bound by theory, it is believed that when an energy source, e.g., UV energy, electron beams, electrical energy, and so forth, is applied to the phosphor composite of the present invention, the phosphor may be excited and, subsequently, emit visible light and UV light as illustrated in FIG. 2A. Once the light is emitted, the phosphor composite may return to its ground state.

In particular, as further illustrated in FIG. 2A, application of energy to the phosphor composite 1 of the present invention may cause the first phosphor layer 50a to emit visible light, e.g., red, blue, or green, as illustrated by the vertical arrows. Simultaneously, the application of energy to the phosphor composite 1 of the present invention may cause the second phosphor layer 52a to emit long wavelength UV light, as illustrated by the horizontal arrow. It should be noted that the direction of the long wavelength UV light illustrated as perpendicular to the direction of the visible light is for the purpose of illustration only. The emission direction of the long wavelength UV light may be radial.

In accordance with the present invention, the visible light emitted from the first phosphor layer 50a may form an image on the display device. Not wanting to be bound by theory, it is further believed that the long wavelength UV light emitted from the second phosphor layer 52a may be absorbed by the first phosphor layer 50a, thereby exciting the first phosphor layer 50a and causing it to emit additional visible light. Since UV light, i.e. UV radiation in the 200 nm to 400 nm range, is weaker and less harmful than other high energy sources, such as radiation having wavelengths shorter than about 200 nm, the additional emission of visible light triggered by UV light minimizes the amount of external high energy absorbed by the first phosphor layer 50a. Additionally, the phosphor composite of the present invention may emit an increased amount of visible light, as compared to a phosphor layer having only a visible light emitting phosphor layer, while utilizing the same amount of external energy, and thereby improve the overall light-emitting efficiency and lifetime of the inventive phosphor composite and display devices employing the inventive phosphor composite. The increase in light-emitting efficiency is illustrated in FIG. 2A.

The light-emitting efficiency of the phosphor composite of the present invention may be maximized by forming its outer layer, i.e., the second phosphor layer 52a, to have a specific thickness. In particular, the thickness of the second phosphor layer 52a may be equal to or less than about 1000 nm. A thickness of more than 1000 nm may form an outer layer that may be too thick for the external energy to penetrate and adequately excite the first phosphor layer 50a to emit sufficient visible light to form images. Preferably, the thickness of the second phosphor layer 52a may be from about 5 nm to about 100 nm.

The thickness of the first phosphor layer 50a may have a lesser effect on the light emission than the second layer 52a, because the first phosphor layer 50a is an inner layer. In other words, the emission and absorption of light of the first phosphor layer 50a may be controlled by the outer layer, i.e., the second phosphor layer 52a, and its thickness. However, the thickness of the first phosphor layer 50a may be at least 10 nm to provide sufficient visible light to form images.

In accordance with another embodiment of the present invention and as illustrated in FIG. 1B, the phosphor composite 10 of the present invention may include a first phosphor layer 50b and a second phosphor layer 52b. The first phosphor layer 50b may be coated on the top surface of the second phosphor layer 52b to form phosphor composite 10, with the first phosphor layer 50b forming an outer layer of the phosphor composite 10. It should be noted that similarly to the previous embodiment described with reference to FIGS. 1A and 2A, the first phosphor layer 50b is selected such that it is capable of emitting visible light when contacted with an external high energy source, and the second phosphor layer 52b is selected such that it is capable of emitting long wavelength UV light when contacted with the same energy source.

It is further noted that the mechanism of light emission from first phosphor layer 50b and second phosphor layer 52b, as illustrated in FIG. 2B, is similar to the light emitting mechanism of first phosphor layer 50a and second phosphor layer 52a described previously with reference to FIGS. 1A and 2A. Accordingly, the details of the mechanism enhancing the light-emitting efficiency of the phosphor composite of the present invention will not be repeated herein.

The light-emitting efficiency of the phosphor composite 10 of the present invention may be maximized by forming its outer layer, i.e., first phosphor layer 50b, to have a specific thickness. In particular, the thickness of the first phosphor layer 50b may control the amount of external energy reaching the inner layer, i.e., the second phosphor layer 52b, in order to emit long wavelength UV light. In particular, the first phosphor layer 50b of the phosphor composite should have a sufficient thickness to emit visible light to form an image. The thickness of the first phosphor layer 50b may be equal to or less than about 2000 nm. Preferably, the thickness of the first phosphor layer 50b may be from about 10 nm to about 1000 nm. In this regard, it should be noted that thickness of less than 10 nm of the first phosphor layer 50b may not provide an adequate amount of visible light for forming an image, while thickness exceeding 2000 nm may form a barrier that is too thick for the external energy or UV light to penetrate, thereby reducing additional emission of visible light.

The thickness of the second phosphor layer 52b may have a lesser effect on the light emission than the first phosphor layer 50b, because the second phosphor layer 52b is an inner layer. However, the thickness of the second phosphor layer 52b may be at least 10 nm to provide sufficient UV light to excite the first phosphor layer 50b.

In accordance with the present invention, any known phosphors in the art that are used in display devices may be employed to form the first phosphor layer, 50a or 50b, of the phosphor composite in the present invention. Examples of phosphors that may be used to form the first phosphor layer, 50a or 50b, of the present invention may include red phosphors, such as (Y,Gd)BO₃:Eu, Y(V,P)O₄:Eu, (Y,Gd)O₃:Eu, and like phosphors; green phosphors, such as Zn₂SiO₄:Mn, (Zn,A)₂SiO₄:Mn (where A is an alkaline-earth metal), (Ba,Sr,Mg)O·aAl₂O₃:Mn (where a is an integer of 1 to 23), MgAlₓO_{y}:Mn (where x is an integer of 1 to 10, and y is an integer of 1 to 30), LaMgAlₓO_{y}:Tb (where x is an integer of 1 to 14, and y is an integer of 8 to 47), ReBO₃:Tb (where Re is a rare earth element including Sc, Y, La, Ce, Gd, and mixtures thereof), (Y, Gd)BO₃:Tb, and like phosphors; blue phosphors, such as BaMgAl₁₀O₁₇:Eu²⁺, ZnS:Ag, Cl, CaMgSi₂O₆:Eu, CaWO₄:Pb, Y₂SiO₅:Eu, and like phosphors; and combinations thereof.

In this regard, it should be noted that among the red phosphors, the use of (Y,Gd)BO₃:Eu may be preferred due to its brightness characteristics. When (Y,Gd)BO₃:Eu is used, it may be possible to minimize the decrease in the brightness following the adjustment of the color temperature of a panel, thereby achieving desirable brightness and color purity. Among the blue phosphors, the use of BaMgAl₁₀O₁₇:Eu²⁺ may be preferred.

In accordance with the present invention, any known phosphors that have light-emitting peaks at wavelengths ranging from about 200 nm to about 400 nm may be employed to form the second phosphor layer, 52a or 52b, of the phosphor composite in the present invention. Examples of phosphors that may be used to form the second phosphor layer, 50b or 52b, in the present invention include phosphors such as (Ba, Mg, Zn)₃SiO₇: Pb²⁺, (Ca,Zn)₃(PO₄)₂:Tl⁺, MgO:Gd³⁺, Y₂O₃:Gd³⁺, SrAl₁₂O₁₉:Ce, BaSi₂O₅:Pb, (Sr,Zn)MgSi₂O₇:Pb, SrB₄O₇:Eu, BaSi₂O₅:Pb²⁺, BaZn₂Si₂O₇:Pb²⁺, BaMg₂Si₂O₇:Pb²⁺, (Ba,Sr,Mg)₃Si₂O₇:Pb²⁺, (Ba,Mg,Mn)₃Si₂O₇:Pb²⁺, (Ba,Zn,Mg)₃Si₂O₇:Pb²⁺, SrB₄O₇:Eu²⁺, YPO₄:Ce, LaPO₄:Ce, (Mg,Ba)Al₁₁O₁₉:Ce, Ca₃(PO4)₂:Tl⁺, and combinations thereof.

The inventive phosphor composite may be prepared according to any methods known in the field. For example, a solution or paste including a second phosphor, i.e. a phosphor that is capable of emitting long wavelength UV light or its precursor, may be prepared. Next, the solution may be evenly mixed with a first phosphor, i.e., a phosphor that emits visible light, and treated in a firing process. If a precursor of a second phosphor is used in the process, it may be selected from organic metal solutions, alkyl silicates, nitrates, alkoxides, and the like. Once the phosphor composite of the present invention is formed, it may be applied to any display device employing a phosphor layer by any method known in the art, such as conventional printing, photosensitive paste preparation, dry film preparation, and other like methods.

As mentioned above, the phosphor composite of the present invention may be applied to any display device employing a phosphor layer. Such displays devices may include a plasma display device (PDP), a cathode ray tube (CRT), a vacuum fluorescent display (VFD), an electron emission device (EED), a light emitting diode (LED), an organic light emitting diode (OLED), a liquid crystal display (LCD), and any other display devices employing phosphorescent materials to emit visible light.

For example, according to one embodiment of the present invention, the inventive phosphor composite may be used in a PDP. A PDP includes two glass substrates coated with a phosphor layer and having vertical and horizontal electrode intersection points with inert gas therebetween. When voltage is applied to the electrodes and causes plasma discharge, UV energy is generated and applied to the phosphor layer, thereby exciting the phosphor layer to emit visible light. The emitted visible light from the phosphor layer forms images on the PDP. When the phosphor composite of the present invention is used in a PDP, the first phosphor layer, 50a or 50b, is excited by the UV energy and emits visible light. Simultaneously, the second phosphor layer, 52a or 52b, is excited as well, thereby emitting long wavelength UV light that further excites the first phosphor layer, 50a or 50b, triggering additional emission of visible light.

Based on the UV light emitted from the second phosphor layer, 52a or 52b, a PDP employing a phosphor composite in accordance with the present invention may have visible light emission that requires reduced UV energy as compared to a PDP employing only visible light emitting phosphor. The reduced UV energy absorbed by the first phosphor layer, 50a or 50b, may further minimize phosphor deterioration. As such, the PDP employing the phosphor composite of the present invention may have increased brightness and color reproducibility, high-quality images, and an enhanced lifetime. Similar advantages may be achieved when the inventive phosphor composite is employed in other display devices utilizing phosphor layers, e.g., CRT, VFD, EED, LED, OLED, LCD, or any other display devices employing phosphorescent materials to emit visible light.

### EXAMPLES

### Examples 1-2

Two phosphor composites were prepared from a red-light-emitting phosphor, i.e., Y(P,V)O₄:Eu³⁺. In Example 1, the phosphor composite was prepared in accordance with the present invention, and included a second phosphor layer, i.e., BaZn₂Si₂O₇:Pb²⁺, in addition to the first phosphor layer, Y(P,V)O₄:Eu³⁺. In Example 2, the phosphor composite was prepared in accordance with the present invention as well, and included a second phosphor layer, i.e., SrB₄O₇:Eu²⁺, in addition to the first phosphor layer, Y(P,V)O₄:Eu³⁺. In Comparative Example 1, only red-light-emitting phosphor layer was used, i.e., second phosphor layer emitting UV light was not used.

The phosphor composites of Examples 1-2 and the phosphor layer of Comparative Example 1 were separately applied to a substrate. The light-emitting efficiency and brightness of each phosphor composite of Examples 1-2 and phosphor layer of Comparative Example 1 was measured.

Comparative Example 1 was set at 100% efficiency and brightness as a reference point. The relative light-emitting efficiency and brightness values of Examples 1-2 were measured relatively to Comparative Example 1, which had no second phosphor layer. Table 1 below illustrates the results:

TABLE 1
Examples 1-2 and Comparative Example 1

| | | | | Compara- |
|---|---|---|---|---|
| | | Example | Example | tive |
| Parts by weight | | 1 | 2 | Example 1 |
| Red light- | Y(P,V)O₄:Eu³⁺ | 95 | 95 | 100 |
| emitting first | | | | |
| phosphor | | | | |
| Second phosphor | BaZn₂Si₂O₇ Pb²⁺ | 5 | — | — |
| | SrB₄O₇Eu²⁺ | — | 5 | — |

| | | | |
|---|---|---|---|
| Relative light-emitting efficiency (%) | 105 | 105 | 100 |
| Relative brightness (%) | 105 | 105 | 100 |

According to Table 1, the phosphor composites that included a second phosphor layer, i.e., a layer that emits long wavelength UV light, showed an increase in light-emitting efficiency and brightness as compared to that of Comparative Example 1, where only a first phosphor layer was used.

### Examples 3-4

Two phosphor composites were prepared from a blue-light-emitting phosphor, i.e., CaMgSi₂O₆:Eu. In Example 3, the phosphor composite was prepared in accordance with the present invention and included a second phosphor layer, BaZn₂Si₂O₇:Pb²⁺, in addition to the first phosphor layer, i.e., CaMgSi₂O₆:Eu. In Example 4, the phosphor composite was prepared in accordance with the present invention as well, and a second phosphor layer, i.e.,SrB₄O₇:Eu²⁺, was used in addition to the first phosphor layer, CaMgSi₂O₆:Eu. In Comparative Example 2, only blue-light-emitting phosphor layer was used, i.e., second phosphor layer emitting UV light was not used.

The phosphor composites of Examples 3-4 and the phosphor layer of Comparative Example 2 were separately applied to a substrate. The light-emitting efficiency and brightness of each phosphor composite of Examples 3-4 and phosphor layer of Comparative Example 2 was measured.

Comparative Example 2 was set at 100% efficiency and brightness as a reference point. The relative light-emitting efficiency and brightness values of Examples 3-4 were measured relatively to Comparative Example 2, which had no second phosphor layer. Table 2 below illustrates the results:

TABLE 2
Examples 3-4 and Comparative Example 2

| | | | | Compara- |
|---|---|---|---|---|
| | | Example | Example | tive |
| Parts by weight | | 3 | 4 | Example 2 |
| Blue light- | CaMgSi₂O₆:Eu | 95 | 95 | 100 |
| emitting first | | | | |
| phosphor | | | | |
| Second phosphor | BaZn₂Si₂O_{7:}Pb²⁺ | 5 | — | — |
| | SrB₄O_{7:}Eu²⁺ | — | 5 | — |

| | | | |
|---|---|---|---|
| Relative light-emitting efficiency (%) | 105 | 105 | 100 |
| Relative brightness (%) | 105 | 105 | 100 |

According to Table 2, the phosphor composites using the second phosphor layer that emitted long wavelength UV light showed an increase in light-emitting efficiency and brightness as compared to that of Comparative Example 2, where only a first phosphor layer was used.

### Examples 5-6

Two phosphor composites were prepared from a green-light-emitting phosphor, i.e., ZnSiO₄:Mn. In Example 5, the phosphor composite was prepared in accordance with the present invention and included a second phosphor layer, i.e., BaZn₂Si₂O₇:Pb²⁺, in addition to the first phosphor layer, ZnSiO₄:Mn. In Example 6, the phosphor composite was prepared in accordance with the present invention as well, and a second phosphor layer, i.e., SrB₄O₇:Eu²⁺, was used in addition to the first phosphor layer, ZnSiO₄:Mn. In Comparative Example 3, only green-light-emitting phosphor layer was used, i.e., second phosphor layer UV light emitting was not used.

The phosphor composites of Examples 5-6 and the phosphor layer of Comparative Example 3 were separately applied to a substrate. The light-emitting efficiency and brightness of each phosphor composite of Examples 5-6 and phosphor layer of Comparative Example 3 was measured.

Comparative Example 3 was set at 100% efficiency and brightness as a reference point. The relative light-emitting efficiency and brightness values of Examples 5-6 were measured relatively to Comparative Example 3, which had no second phosphor layer. Table 3 below illustrates the results:

TABLE 3
Examples 5-6 and Comparative Example 3

| | | | | Compara- |
|---|---|---|---|---|
| | | Example | Example | tive |
| Parts by weight | | 5 | 6 | Example 3 |
| Green light- | ZnSiO₄:Mn | 95 | 95 | 100 |
| emitting first | | | | |
| phosphor | | | | |
| Second phosphor | BaZn₂Si₂O_{7:}Pb²⁺ | 5 | — | — |
| | SrB₄O_{7:}Eu²⁺ | — | 5 | — |

| | | | |
|---|---|---|---|
| Relative light-emitting efficiency (%) | 108 | 109 | 100 |
| Relative brightness (%) | 107 | 110 | 100 |

According to Table 3, the phosphor composites using the second phosphor layer showed an increase in light-emitting efficiency and brightness as compared to that of Comparative Example 3, where only the first phosphor was used.

It should be noted with reference to Examples 1-6 and Comparative Examples 1-3, that relative light emitting efficiency was determined as the increase in visible light emission in the phosphor composites of the present invention as compared to the visible light emission in phosphors having only visible light layers, i.e., phosphors having no UV light emitting layers. In other words, the visible light emission in Comparative Examples 1-3 was measured and set as an absolute value of 100%. The measurement data of the visible light emission in Examples 1-2, 3-4, and 5-6 was compared to the corresponding values measured in Comparative Examples 1-3, respectively, and a percentage increase in visible light emission in each case was calculated relatively to the corresponding absolute value of 100%. For example, the visible light emission of the phosphor composite in Example 1 was 5% higher than that of the phosphor layer in Comparative Example 1. Therefore, the relative light-emitting efficiency of the phosphor composite of Example 1 was calculated as 105%.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A phosphor composite comprising:
a first phosphor layer emitting visible light; and
a second phosphor layer emitting long wavelength UV light from about 200 nm to about 400 nm.

2. The phosphor composite as claimed in claim 1, wherein the second phosphor layer is attached to a top of the first phosphor layer to form an outer layer of the phosphor composite.

3. The phosphor composite as claimed in claim 2, wherein the second phosphor layer includes one or more of (Ba,Mg,Zn)₃SiO₇:Pb²⁺, (Ca,Zn)₃(PO₄)₂:Tl⁺, MgO:Gd³⁺, Y₂O₃:Gd³⁺, SrAl₁₂O₁₉:Ce, BaSi₂O₅:Pb, (Sr,Zn)MgSi₂O₇:Pb, SrB₄O₇:Eu, BaSi₂O₅:Pb²⁺, BaZn₂Si₂O₇:Pb²⁺, BaMg₂Si₂O₇:Pb²⁺, (Ba,Sr,Mg)₃Si₂O₇:Pb²⁺, (Ba,Mg,Mn)₃Si₂O₇:Pb²⁺, (Ba,Zn,Mg)₃Si₂O₇:Pb²⁺, SrB₄O₇:Eu²⁺, YPO₄:Ce, LaPO₄:Ce, (Mg,Ba)Al₁₁O₉:Ce, and Ca₃(PO4)₂:Tl⁺.

4. The phosphor composite as claimed in claim 2, wherein the thickness of the second phosphor layer is equal to or less than about 1000 nm.

5. The phosphor composite as claimed in claim 4, wherein the thickness of the second phosphor layer is from about 10 nm to about 100 nm.

6. The phosphor composite as claimed in claim 1, wherein the first phosphor layer is attached to a top of the second phosphor layer to form an outer layer of the phosphor composite.

7. The phosphor composite as claimed in claim 6, wherein the second phosphor layer includes one or more of (Ba,Mg,Zn)₃SiO₇:Pb²⁺, (Ca,Zn)₃(PO₄)₂:Tl⁺, MgO:Gd³⁺, Y₂O₃:Gd³⁺, SrAl₁₂O₁₉:Ce, BaSi₂O₅:Pb, (Sr,Zn)MgSi₂O₇:Pb, SrB₄O₇:Eu, BaSi₂O₅:Pb²⁺, BaZn₂Si₂O₇:Pb²⁺, BaMg₂Si₂O₇:Pb²⁺, (Ba,Sr,Mg)₃Si₂O₇:Pb²⁺, (Ba,Mg,Mn)₃Si₂O₇:Pb²⁺, (Ba,Zn,Mg)₃Si₂O₇:Pb²⁺, SrB₄O₇:Eu²⁺, YPO₄:Ce, LaPO₄:Ce, (Mg,Ba)Al₁₁O₁₉:Ce, and Ca₃(PO4)₂:Tl⁺.

8. The phosphor composite as claimed in claim 6, wherein the thickness of the first phosphor layer is equal to or less than about 2000 nm.

9. The composite phosphor as claimed in claim 8, wherein the thickness of the first phosphor layer is from about 10 nm to about 1000 nm.

10. A display device, comprising a phosphor composite including a first phosphor layer emitting visible light and a second phosphor layer emitting long wavelength UV light of from about 200 nm to about 400 nm.

11. The display device as claimed in claim 10, wherein the display device includes one or more of a plasma display panel, a cathode ray tube, a vacuum fluorescence display, an electron emission device, a light emitting diode, and a liquid crystal display.
